(19) United States
(12) Patent Application Publication
(10) Pub. No.: US 2004/0254280 A1
(43) Pub. Date: Dec. 16, 2004

(54) Blends of waxes and polymer additives

(76) Inventors: Eric Richter, Thierhaupten (DE); Christian Lechner, Hurlach (DE); Rainer Bott, Seeth-Ekholt (DE)

Correspondence Address: CLARIANT CORPORATION, INTELLECTUAL PROPERTY DEPARTMENT, 4000 MONROE ROAD, CHARLOTTE, NC, 28205, US

(21) Appl. No.: 10/493,145

(22) PCT Filed: Oct. 10, 2002
(86) PCT No.: PCT/EP02/11334

(30) Foreign Application Priority Data
Oct. 20, 2001 (DE) 101 52 228.2

(51) Int. Cl. C08L 1/00

(52) U.S. Cl. 524/400

(57) ABSTRACT

The invention relates to blends of waxes (component A) and polymer additives (component H) and to the use thereof.

The invention relates to blends of waxes and polymer additives and to the use thereof.

With a few exceptions, further plastics are processed in the melt. The associated changes in structure and state cause some alteration in the chemical structure of almost every plastic. The consequence can be crosslinking, oxidation, and molecular weight changes, and therefore also changes in physical and technical properties. To reduce the stress to which polymers are exposed during their processing, various additives are used, as required by the particular plastic.

For this reason, stabilizers are added to some plastics, and these suppress, or at least retard, alteration processes such as crosslinking reactions or degradation reactions. Lubricants, in particular montan waxes, are also admixed with most plastics, and these have the function of improving the flow behavior of the melt. The considerable amounts of lubricants achieve this by reducing internal and external friction and thus reducing the degradation of the material caused by mechanical/chemical effects.

A wide variety of additives is generally used simultaneously, each of these having its own function. For example, antioxidants and stabilizers are used so that the plastic withstands processing without degradation of its chemical structure and is then resistant over long periods to external effects, such as heat, UV light, weathering, and oxygen (air).

The function of lubricants is to permit control and adequate distribution of the plastic within the processing machinery, so that the plastic takes the form of a homogeneous melt, and to prevent excessive adhesion of the molten plastic to hot components of the machinery, and to improve the flow properties of the molten plastic, and to act as a dispersing agent for pigments, fillers, and reinforcing materials.

The prior art uses various waxes as (mold-)release agents in plastics, in particular in polyamides. However, the high processing and service temperatures of the polyamides and their high reactivity severely restrict the choice of possible additives. Among the most frequently used groups of products are metal stearates, amide wax, and montan wax esters, used in the form of various products, as requirements dictate. All three of these product groups act as (mold-)release agents.

The metal stearates at the same time improve the flowability of the melt. However, this flowability is brought about by a considerable reduction in the molecular weight of the polymer, particularly as a consequence of the hygroscopic behavior of polyamide. In contrast, the montan wax esters and their salts improve the flowability of polyamide plastics solely by way of internal lubricant action, without reducing the molecular weight of the polymer.

Especially in the case of polyamide, coloring is subject to particularly stringent requirements as a consequence of the high processing temperatures, and also of the aggressive chemical behavior of the melt toward colorants.

The choice of colorants which can be used is just as restricted as the choice of suitable dispersing agents. Even heat-resistant pigments frequently sustain lasting degradation due to the high added shear-energy levels present during the dispersion process. Highly resistant pigments are frequently not available commercially in any relatively large amounts, and attempts are therefore being made to achieve the appropriate optimization of the dispersing agents.

Montan waxes have proven successful in this context for some decades. Their lubricant action permits the non-aggressive incorporation of sensitive pigments (alone or combined with other organic or inorganic pigments, additives, fillers), but on the other hand they also have sufficient thermal stability, have good compatibility with the polyamide melt, and moreover give no problems during further processing. The same applies to modified materials whose preparation is based on montan wax and which have been optimized for a particular purpose.

Besides the exclusive use of montan waxes as dispersing agents for pigments, it is also possible to use various amide waxes. Some combinations of the two can also be found, for example in order to utilize the action of the montan wax in promoting dispersion but to reduce formulation costs through a less expensive product (amide wax).

Particularly when a polyamide color concentrate is to be used to produce fiber-reinforced parts, the stability of the concentrate, and, of course, of its individual components, acquires particular significance: colorants can become degraded in the final application as a result of the increased amount of shear-generated heat (this effect being additional to the processing temperature, which is in any event high), although they remained (as yet) undegraded after the compounding or dispersing step. Attempts are usually made to counter the problem via downstream process stabilization. However, the homogenization achieved during downstream stabilization is frequently inadequate, particularly when a pulverulent stabilizer is added to the plastics pellets.

Very high temperatures prevail during the processing of many plastics, in particular the polyamides, and these degrade the polymer. In addition, prolonged exposure to air, light, and heat has an adverse effect on the properties of the plastic. Plastics are widely-stabilized in order to suppress degradation during processing and during service life. In particular, copper salts, aromatic amines, and sterically hindered phenols have proven successful in various combinations for different applications. N,N′-bis-(2,2,6,6-tetramethyl-4-piperidyl)-1,3-benzenedicarboxamide is likewise known as a multifunctional additive (process stabilizer and heat stabilizer) for polyamides.

The abovementioned additives may be introduced into the plastic in a very wide variety of steps of the process. For example, in the case of polyamides it is possible to incorporate the waxes into the polyamide melt as early as the end of the polycondensation, or in a subsequent compounding process. There are also processes in which the waxes are not added until later. This method is particularly practiced when using wax-containing pigment masterbatches or wax-containing additive masterbatches. In another possible method, pulverulent waxes in particular are applied in a drum mixer to the polyamide pellets, which may retain heat from the drying process.

There remain inadequacies in the previously known prior art in relation to the effects of the various auxiliaries and agents listed with respect to a plurality of properties, e.g. internal and external lubricant action, and also dispersion of pigments and fillers, and the gloss of the plastic.

It was therefore an object of the present invention to provide auxiliaries or additives which have overall improved effect on the plastic, in particular in the case of polyamides.

This object is achieved by way of a blend of a wax (component A) and a polymer additive (component B).

Surprisingly, it has been found that, when comparison is made with the use of the individual substances or else a plurality of other waxes, a combination composed of montan waxes and polymer additives gives the best results with respect to internal and external lubricant action, and also dispersion of pigments and fillers, and gloss, through synergistic effects, in particular in polyamides.

A preferred component A is an ester wax and/or a salt of a carboxylic acid.

Another preferred component A is products of the reaction of montan wax acids with ethylene glycol.

The products of the reaction are preferably a mixture of the mono(montan wax acid) ester of ethylene glycol, the di(montan wax acid) ester of ethylene glycol, montan wax acids, and ethylene glycol.

Another preferred component A is products of the reaction of montan wax acids with a calcium salt.

The products of the reaction are particularly preferably a mixture of the mono(montan wax acid) ester of 1,3-butanediol, the di(montan wax acid) ester of 1,3-butanediol, montan wax acids, 1,3-butanediol, calcium montanate, and the calcium salt.

A preferred component B is a derivative of an aromatic di- or tricarboxylic (ester) amide.

A preferred derivative is N,N′-bispiperidyl-1,3-benzenedicarboxamide. Another preferred derivative is N,N′-bis(2,2,6,6-tetramethyl-4-piperidyl)-1,3-benzenedicarboxamide.

The blend preferably comprises from 10 to 90% by weight of component A and from 90 to 10% by weight of component B.

The blend preferably comprises from 30 to 70% by weight of component A and from 70 to 30% by weight of component B.

The blend preferably comprises from 45 to 55% by weight of component A and from 45 to 55% by weight of component B.

Components A and B preferably take the form of pellets, flakes, fine particles, powders, and/or micronizate.

Components A and B preferably take the form of a physical mixture of the solids, a melt mixture, a compactate, or take the form of a masterbatch.

The invention also provides the use of the inventive blend as lubricant, release agent, and/or dispersing agent.

The blend is preferably used in a molding composition of a polycondensate.

The polycondensate is preferably polyamide.

The polyamides are preferably of amino-acid type and/or of diamine-dicarboxylic-acid type.

The polyamides are preferably nylon-6 and/or nylon-6,6.

The polyamides are preferably unmodified, colored, filled, unfilled, reinforced, or unreinforced polyamides, or else polyamides which have been otherwise modified.

Components A and B are preferably introduced in the same or different steps of the process during the preparation/processing of polyamides.

Components A and B are preferably incorporated during polycondensation, during compounding, or directly during the shaping process.

The total amount of components A and B is preferably from 0.01 to 10.00% by weight in the polycondensate.

The total amount of components A and B is particularly preferably from 0.1 to 2.00% by weight in the polycondensate.

Suitable lubricants derive from the montan waxes group. Chemically, the montan waxes are among the acid waxes and ester waxes. Very generally, they may be described as a mixture of a long-chain linear saturated carboxylic acid with various esters of this carboxylic acid with different alcohols and with the salts of the carboxylic acids. These products very generally also comprise what is known as native montan wax, which is the ester of a long-chain carboxylic acid with a long-chain monohydric alcohol. The chain length of the carboxylic acids present in montan waxes is from 24 to 36 carbon atoms.

Various products are commercially important in the plastics industry sector. For example, use is especially made of the esters of montan wax acid with glycol, glycerol, butanediol(1,3- and 1,4-), trimethylolpropane, pentaerythritol, and dipentaerythritol. Partially hydrolyzed products thereof are also used. A feature of all of these products is that their hydrolysis number, their acid number, and, where appropriate, their metal content can be varied within wide ranges, thus permitting the products to be adapted to the application.

The suitable montan waxes comprise the product of the reaction of montan wax acid or, respectively, a mixture of native montan wax esters and of montan wax acids, with ethylene glycol to give a mixture of the mono- and diester and of the starting materials (e.g. ®Licowax E, Clariant GmbH). The calcium salt of the montan wax acids is also particularly suitable. This product is a product of the reaction of montan wax acid or, respectively, a mixture of native montan wax esters arid of montan wax acids, with a calcium salt to give a mixture of calcium montanate and the starting materials (e.g. ®Licomont CaV 102, Clariant GmbH).

The suitable polymer additives comprise compounds of the type represented by the aromatic di- or tricarboxylic esters or aromatic di- or tricarboxamides. In particular, it has been found that substituted substances of the type represented by N,N′-bispiperidyl-1,3-benzenedicarboxamide, such as N,N′-bis(2,2,6,6-tetramethyl-4-piperidyl)-1,3-benzenedicarboxamide (Nylostab® S-EED, Clariant GmbH) are suitable.

The internal, and also external, lubricant action of the inventive mixture composed of a wax (component A) and of a polymer additive (component B) is therefore markedly higher when comparison is made with the use of conventional waxes at the same total concentration. The combined use of the two components, i.e. of the mixture, increases the flowability of the compounded material markedly when comparison is made with the individual substances. At the same time, this combination has very powerful release action. The tendency of the polyamide molding composition to adhere to hot machinery parts is markedly reduced.

Furthermore, the use of an inventive mixture composed of a wax (component A) and of a polymer additive (component B) markedly improves the optical properties of a polyamide molding (surface luster).

In pigment masterbatches using polyamide as carrier material, the use of the inventive mixture composed of a wax (component A) and of a polymer additive (component B) leads to improvement of properties, in particular to a finer and more uniform distribution of pigments and of fillers. This improved dispersing action is discerned in test procedures via a markedly lower filter pressure value, and also via increased color strength.

This synergy observed for the inventive mixture composed of a wax (component A) and of a polymer additive (component B) is surprising, since the chemical structures and the known mechanisms of action lead to no expectation of interactions between these waxes and polymer additives.

The pulverulent or fine-particle substances are incorporated by mixing or absorption of the substances onto the cold or warm carrier polymer, followed by processing through a shaping step (e.g. injection molding, flat-film production, calendering, etc.) or by prior incorporation through compounding by means of an extruder, where both components may be metered by means of lateral feed or incorporated by prior mixing into the polyamide. Possible materials here are simple physical mixtures of the solids, melt mixtures, and compactates.

Release Action (External Lubricant Action)

Lubricants in the form of external lubricants are used in the plastics industry in order to inhibit adhesion of the hot plastics melt to the hot metal surfaces of the processing machinery. They form a lubricant film between the metal surface and the polymer melt, and function here as release agents.

The release action (external lubricant action) of lubricants in engineering plastics, such as polyamide, is usually quantified by measuring the demolding force during injection molding. For this, a cylindrical shell is produced by the injection-molding process, and the demolding force recorded is the maximum force needed to demold the shell from the mold. The lower the demolding force, the better the external lubricant action of the lubricant used.

The studies used a specific grade of nylon-6 in which no lubricants of any kind are present, so that the determination revealed exclusively the action of the additives to be studied. This means that this grade cannot be processed until lubricants have been added. The demolding force is >10 000 N.

In the case of polyamide, the concentration of lubricants with the best cost/performance ratio is usually about 0.3 phr (parts per hundred resin). The lubricants and additives used were incorporated by mixing into the polymer pellets, and by compounding by means of a twin-screw extruder, and the mixture was then processed by means of injection molding, after predrying.

All of the experiments were carried out under identical conditions (temperature programs, screw geometries, injection-molding parameters, etc.) for reasons of comparability.

### EXAMPLE 1

| | |
|---|---|
| Nylon-6, unreinforced | |
| 0.15 phr of Nylostab S-EED* + 0.15 phr | 400 N |
| calcium montanate | |
| Comparison: | |
| Nylon-6 without lubricant | >10 000 N |
| 0.3 phr Nylostab S-EED* | 1 500 N |
| 0.3 phr calcium montanate | 550 N |
| 0.3 phr montan wax ester | 550 N |
| (*Nylostab S-EED is N,N-bis(2,2,6,6-tetramethyl- | |
| 4-piperidyl)-1,3-benzenedicarboxamide) | |
| Nylon-6, glass-fiber-reinforced | |
| 0.15 phr of Nylostab S-EED + 0.15 phr | 850 N |
| calcium montanate | |
| 0.15 phr of Nylostab S-EED + 0.15 phr | 800 N |
| montan wax ester | |
| Comparison: | |
| Nylon-6 (30% glass fiber) without lubricant | 2 500 N |
| 0.3 phr of calcium montanate | 1 000 N |
| 0.3 phr of montan wax ester | 900 N |

The sole use of calcium montanate or of montan wax ester is prior art.

Flow Improvement in Polyamide (Internal Lubricant Action)

Lubricants in the form of internal lubricants are used in the plastics industry in order to reduce the friction of the polymer particles during the procedure of processing. They therefore raise the flowability of the polymer. The improvement in flow (internal lubricant action) provided by lubricants in engineering plastics, such as polyamide, is usually quantified by determining the flow distance by means of a “spiral test”. For this, a graduated spiral is produced by the injection-molding process, and its length is determined. The longer the flow path (i.e. the spiral), the better the internal lubricant action, i.e. the flowability of the polymer.

The lubricants and additives used were incorporated by mixing into the polymer pellets and by compounding by means of a twin-screw extruder, and then processed by injection molding after predrying. All of the experiments were carried out under constant processing conditions for reasons of comparability. The specific polyamide from example 1 was used.

### EXAMPLE 2

| | |
|---|---|
| 0.15 phr Nylostab S-EED + 0.15 phr | 42.0 cm |
| calcium montanate | |
| Comparison: | |
| 0.3 phr Nylostab S-EED | 40.5 cm |
| 0.3 phr calcium montanate | 41.0 cm |

In addition, this flow improvement could not be achieved by any of the other lubricants tested, these being used by the prior art in polyamides.

Gloss of Compounded Polyamide Materials

Lubricants very frequently impair the gloss of the final polyamide product. It is desirable to minimize the adverse gloss effect caused by the lubricants added.

The usual method of gloss determination uses a reflectometer in which the reflected light is measured for a particular angle of incidence (reflection angle). The higher the number of gloss units, the higher is the surface gloss. According to DIN 67530, surfaces which, as in the present case, exhibit values above 70 units at a 60° reflection angle are to be tested at a reflection angle of 20°. The following values were obtained for measurement at a reflection angle of 20°: the injection-molded plaques for the gloss measurement were produced under constant conditions, for reasons of comparability.

### EXAMPLE 3

| | |
|---|---|
| 0.15 phr Nylostab S-EED/0.15 phr | 89 gloss units |
| calcium montanate | |
| Comparison: | |
| Nylon-6 without lubricant | 87 gloss units |
| 0.3 phr Nylostab S-EED | 65 gloss units |
| 0.3 phr calcium montanate | 70 gloss units |

Dispersion of Pigments in Polyamides

The prior art for coloring polyamide with organic pigments uses what are known as masterbatches, which are color concentrates whose carrier material comprises polyamide. For good dispersion of the pigments, waxes are used by the prior art as dispersing agents, in order to achieve good dispersion and thus ideal color yield.

Especially in the case of masterbatches using engineering plastics, such as polyamide, montan waxes are used as dispersing agents for wetting of the pigments, in order to break down pigments which tend to agglomerate and are difficult to disperse. This effect is quantified by way of what is known as the filter pressure test, in which the pressure increase upstream of a filter of particular mesh width is measured, the increase being greater as the size of the agglomerates increases with the result that they block the filter. Pigments which have been better dispersed have better capability to pass through the filter, and dispersion quality is higher. A small filter-pressure value measured in [bar/g of pigment] is therefore a measure of good dispersing action of the lubricants.

PV Fast Pink was chosen as pigment, because it has low dispersibility in polyamide. Additive-free nylon-6 was used as carrier, and it was therefore possible to study the isolated action of the additives added. Surprisingly, it was found here that the inventive combinations composed of montan waxes, such as montan wax esters or calcium montanate, with Nylostab S-EED give extremely good dispersion, i.e. give low filter-pressure values, this dispersion not being achievable through any other combination.

The pigments and additives were incorporated by means of cold mixing and by compounding in a twin-screw extruder. The pressure-filter value was then determined by way of a 14 μm filter.

The following formulations were used and the following filter-pressure values were determined:

### EXAMPLE 4

| | | | | | | | | |
|---|---|---|---|---|---|---|---|---|
| Unreinforced | 60% | 60% | 60% | 65% | 65% | 65% | 65% | 65% |
| nylon-6 | | | | | | | | |
| PV Fast Pink E | 30% | 30% | 30% | 30% | 30% | 30% | 30% | 30% |
| Nylostab | 5% | 5% | | | | | | |
| S-EED | | | | | | | | |
| Calcium | 5% | | 10% | | | | | |
| montanate | | | | | | | | |
| Montan wax | | 5% | | 5% | | | | |
| ester | | | | | | | | |
| Licowax OP | | | | | 5% | | | |
| Licolub WE 40 | | | | | | 5% | | |
| Licolub WE 4 | | | | | | | 5% | |
| Ceridust ® | | | | | | | | 5% |
| 5551 | | | | | | | | |
| Filter-pressure | 4.0 | 3.6 | 18.0 | 6.0 | 11.4 | 13.4 | 12.0 | 16.6 |
| value [bar/ | | | | | | | | |
| g of pigment] | | | | | | | | |

All of the waxes used, at comparable concentration, provided poorer filter values and therefore poorer dispersing action when comparison is made with the inventive additive combination.

1. A blend of at least one wax (component A) and at least one polymer additive (component B), wherein the at least one wax is the products of the reaction of montan wax acids with ethylene glycol or is or the products of the reaction of montan wax acids with a calcium salt, and at least one polymer additive is N,N′-bis-piperidyl-1,3-benzenedicarboxamide or is N,N′-bis(2,2,6,6-tetra-methyl-4-piperidyl)-1,3-benzenedicarboxyamide, and where the blend comprises from 45 to 55% by weight of component A and from 45 to 55% by weight of component B.

2. The blend as claimed in claim 1, wherein the products of the reaction of montan wax acids with ethylene glycol are a mixture of the mono(montan wax acid) ester of ethylene glycol, the di(montan wax acid) ester of ethylene glycol, montan wax acids, and ethylene glycol.

3. The blend as claimed in claim 1, wherein the products of the reaction of montan wax acids with a calcium salt are a mixture of the mono(montan wax acid) ester of 1,3-butanediol, the di(montan wax acid) ester of 1,3-butanediol, montan wax acids, 1,3-butanediol, calcium montanate, and the calcium salt.

4. The blend as claimed in claim 1, comprising from 10 to 90% by weight of component A and from 90 to 10% by weight of component B.

5. The blend as claimed in claim 1, comprising from 30 to 70% by weight of component A and from 70 to 30% by weight of component B.

6. The blend as claimed in claim 1, wherein components A and B take the form selected from the group consisting of pellets, flakes, fine particles, powders, micronizate and mixtures thereof.

7. The blend as claimed in claim 1, wherein components A and B take the form of a physical mixture selected from the group consisting of solids, a melt mixture, a compactate, and a masterbatch.

8. A composition comprising the blend as claimed in claim 1, wherein the composition is selected from the group consisting of a lubricant, release composition, and dispersing composition.

9. A method of forming a polycondensate comprising the steps of:
polycondensing at least two compounds to form a polycondensate;
compounding the polycondensate;
shaping the polycondensate
adding, in a first adding step, at least one wax, wherein the at least one wax is the products of the reaction of montan wax acids with ethylene glycol or the products of the reaction of montan wax acids with a calcium salt;
adding, in a second adding step, at least one polymer additive, wherein the at least one polymer additive is N,N′-bispiperidyl-1,3-benzenedicarboxamide or is N N′-bis(2,2,6,6-tetra-methyl-4-piperidyl)-1,3-benzenedicarboxyamide; and
wherein the first adding step and the second adding step, independently, are performed during the polycondensing, compounding or shaping step.

10. The method as claimed in claim 9, wherein the polycondensate is a polyamide.

11. The method as claimed in claim 10, wherein the polyamide is selected from the group consisting of an amino-acid type, a diamine-dicarboxylic-acid type, and mixtures thereof.

12. The method as claimed in claim 10, wherein the polyamide is selected from the group consisting of nylon-6, nylon-6,6 and mixtures thereof.

13. The method as claimed in claim 10, wherein the polyamide is selected from the group consisting of unmodified, modified, colored, filled, unfilled, reinforced, and unreinforced polyamides.

14. (Cancelled)

15. (Cancelled)

16. The method as claimed in claim 9, wherein the total amount of the at least one wax and the polymer additive is from 0.01 to 10.00% by weight in the polycondensate.

17. The method as claimed in claim 9, wherein the total amount of the at least one wax and the polymer additive is from 0.1 to 2.00% by weight in the polycondensate.

18. A polycondensate made in accordance with the method of claim 9.
